(19) United States
(12) Patent Application Publication
(10) Pub. No.: US 2023/0237130 A1
(43) Pub. Date: Jul. 27, 2023

(54) MULTI-LAYERED AUTHENTICATION AND PERMISSION METHODS, SYSTEMS AND APPARATUSES

(71) Applicant: Cypress Semiconductor Corporation, San Jose, CA (US)

(72) Inventors: Bradley EVANS, Northville, MI (US); Nicholas STOPHER, Novi, MI (US)

(73) Assignee: Cypress Semiconductor Corporation, San Jose, CA (US)

(21) Appl. No.: 17/885,851

(22) Filed: Aug. 11, 2022

Related U.S. Application Data
(60) Provisional application No. 63/303,763, filed on Jan. 27, 2022.

(51) Int. Cl. G06F 21/32; G06F 21/43; G06F 21/60

(52) U.S. Cl. CPC G06F 21/32; G06F 21/43; G06F 21/604

(57) ABSTRACT

A method can include receiving user input values via a plurality of inputs of a motor vehicle and determining if each received user input value corresponds to an authenticated user value in a secure memory of the motor vehicle. For each received user input value corresponding to an authenticated user value, a certainty factor corresponding to the authenticated user value can be accessed from a secure memory. A certainty score can be generated from all accessed certainty factors. Each of a plurality of permissions for operating or accessing the motor vehicle can be enabled in response to a comparison between the certainty score and a certainty threshold assigned to each permission. Corresponding devices and systems are also disclosed.

### RELATED APPLICATIONS

This application claims the benefit of U.S. Provisional Patent Application Ser. No. 63/303,763 filed Jan. 27, 2022, the contents of which are incorporated by reference herein.

### TECHNICAL FIELD

The present disclosure relates generally to authentication systems, and more particularly to systems that can provide different levels of authentication and/or permissions based on multiple user authentication sources.

### BACKGROUND

Conventional security systems, such as those used for motor vehicles, can use one device to provide full access and control of a system. For example, key fobs enable a user to enter and operate a motor vehicle. Motor vehicles can also be equipped with phone-as-a-key (PaaK) systems, which can allow a smart phone to provide the same access/control function as a key fob.

A drawback to such conventional approaches can be the inconvenience of having no access to a system in the event the device (i.e., key fob or phone) is lost, or left elsewhere. Replacement of such devices can take a considerable amount of time and be costly. Still further, in the case of key fobs and unlocked phones, a system can be accessed by anyone in possession of the device.

It would be desirable to arrive at some way of providing access to systems that is more convenient than conventional approaches, but still provide a high degree of security.

### SUMMARY

Embodiments can include systems, methods and devices that can enable access to systems based on multi-layered authentication and permissions. Multi-layered authentication can generate a “certainty score” from multiple devices or data sources for a particular user. A system, such as a motor vehicle, can have different permissions (e.g., full access and control, entry access, access to trunk etc.). Each such permission can be assigned a certainty threshold. A certainty score for a user can be compared to the certainty threshold for each permission to determine if that permission is granted to the user. In this way, permissions can be based on multiple devices and/or data sources, rather than one device.

### BRIEF DESCRIPTION OF THE DRAWINGS

FIG. 1 includes diagrams showing multi-layer authentication data according to embodiments.

FIG. 2 is a representation of multi-layer authentication and permission according to an embodiment.

FIG. 3 is a diagram showing system accesses according to an embodiment.

FIGS. 4A and 4B show how different numbers of authentication sources can result in different levels of access (permissions).

FIGS. 5A and 5B are diagrams showing a delivery system according to an embodiment.

FIG. 6 is a diagram of a motor vehicle system and operations according to an embodiment.

FIG. 7 is a diagram of a motor vehicle system according to another embodiment.

FIG. 8A is a diagram of a campus system according to an embodiment.

FIGS. 8B and 8C are diagrams are diagrams showing a “Car as a Key” system and methods according to embodiments.

FIG. 9 is a block diagram of an automotive control system according to an embodiment.

FIGS. 10A and 10B are diagrams showing integrated circuit device systems according to embodiments.

FIG. 11 is a flow diagram of a method according to an embodiment.

FIG. 12 is a flow diagram of a method for configuring an access profile according to an embodiment.

FIG. 13 is a flow diagram of a method for assigning certainty threshold (CF) values according to an embodiment.

FIG. 14 is a flow diagram of a method for granting various levels of access/permission to a system based on multiple authentication sources according to an embodiment.

FIG. 15 is a flow diagram of a method for authenticating devices/data for inclusion in a multi-layer authentication and permissions (MLAP) determination, according to an embodiment.

FIG. 16 is a diagram of packets that can identify MLAP compatible devices according to embodiments.

FIG. 17 is a flow diagram of a motor vehicle permission control method according to an embodiment.

FIG. 18 is a flow diagram of a method for receiving authenticating device data according to an embodiment.

FIGS. 19A to 19G are a sequence of diagrams showing an authentication application according to an embodiment.

### DETAILED DESCRIPTION

According to embodiments, a system can receive user identifying (ID) data from multiple sources, including from user devices (e.g., wireless device) and user inputs (e.g. fingerprint sensors, user interfaces). User ID data can be compared to values in a secure memory to determine a corresponding certainty factor (CF). Multiple CFs for a same user can be used to arrive at an overall certainty score (CS) for that user. Permissions for various features of the system can be enabled or disabled based on the CS.

Embodiments can include motor vehicle systems having multiple permissions with assigned certainty thresholds. Such permissions can include higher level permissions (e.g., full control of the motor vehicle) as well as lower level permissions (e.g., access to trunk). Permissions can be enabled or disabled according to a comparison between the certainty threshold (CT) of the permission, and the overall CS.

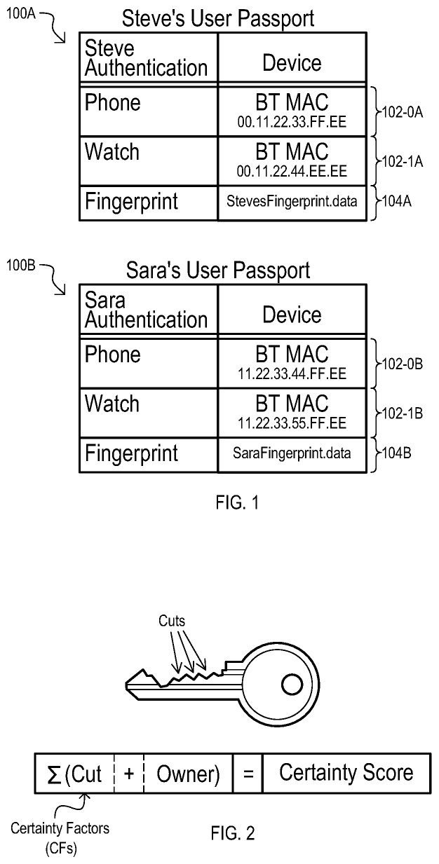

FIG. 1 includes diagrams showing multi-layer authentication data according to embodiments. Authentication data can correspond to one or more particular users, and can originate from various sources. FIG. 1 shows authentication information for one user “Steve” and another user “Sara”. The multiple sources of authentication data for a user can be considered a “passport” 100A and 100B. While authentication data can take any suitable form, passports 100A/B show how authentication data can include information transmitted from a device 102-0A/B and 102-1A/B, as well as biometric identification (ID) information corresponding to a physical sensor 104A/B.

Transmitted information can include data values assigned to a device which can be detected by wireless circuits of a system. Device ID identification values used for multi-layered authentication can include a phone ID 102-0A/B and a wearable device (watch) ID 102-1A/B. In the embodiment shown, such values can be Bluetooth (BT) media access control (MAC) address values.

Biometric information 104A/B can include fingerprint data files. Such biometric ID files can be stored by a system for comparison to input files generated by sensors. As will be described further herein, biometric data can take any suitable form, including but not limited to: facial recognition, voice recognition, iris or retina recognition, and gait recognition.

Passports 100A/B can be established by an application and can be stored locally on a device and/or remotely in a server (e.g., in the cloud).

In this way the ability of user to access features of the system (e.g., user permissions) can depend on multiple authentication data sources for that user.

FIG. 2 is diagram showing one way of conceptualizing multi-layered authentication and permission according to embodiments. Each source of authentication data can be assigned a CF, which can be analogous to “cuts” in a physical key. Authentication data need not originate from the same user, but can also be from another person that is added/authorized by the user.

Multiple CFs for the user can be summed (or subject to some other mathematical operation that incorporates all CFs) to generate an overall CS. The CS can be used to enable or disable various permissions of a system (e.g., the higher the CS the higher the permissions granted, or vice versa).

In this way, multiple, different sources of authentication data can be used to arrive at an overall certainty score, which can determine levels of permission for a user of a system.

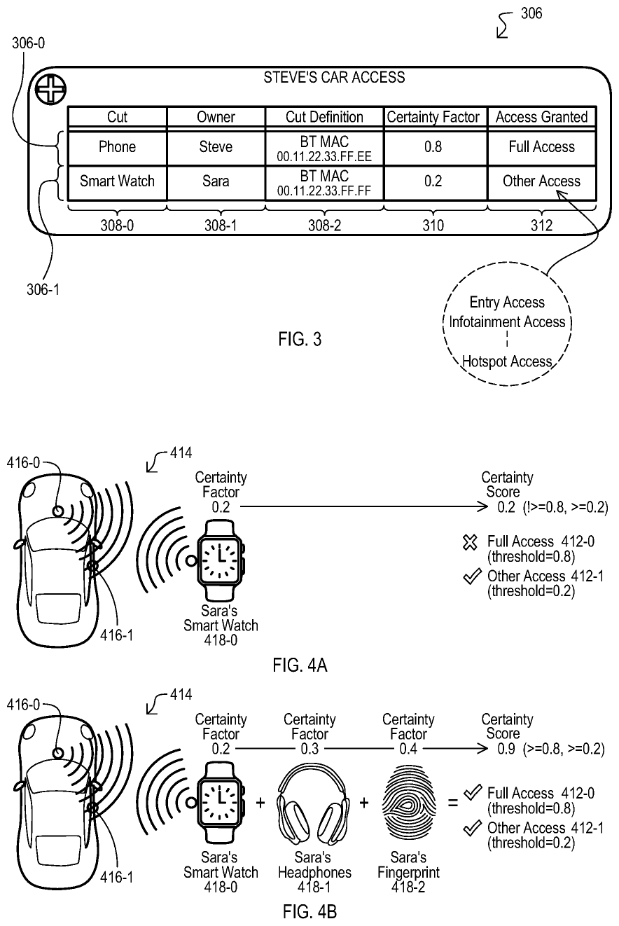

FIG. 3 is a diagram showing how different authentication sources can enable different types of permission. FIG. 3 shows values for a motor vehicle (Steve's Car), and in some embodiments can be a menu 306 presented by an interface for a system. Such an interface and corresponding data values can be local to a system (part of the motor vehicle) or remote (presented by another device and stored on a server or the like).

FIG. 3 shows two types of entries. Entry 306-0 can be for a primary user of the system (i.e., Steve). Entry 306-1 can be for a user that is not the primary user of the system (i.e., Sara). In some embodiments, an entry 306-1 can be added or authorized by the primary user. Each entry 306-0/1 can include a cut value 308-0, owner value 308-1, cut definition 308-2, CF 310 and type of access (e.g. permission) granted 312. A cut value 308-0 can describe the source of data, an owner 308-1 can be a user associated with the data. A cut definition 308-2 can be the authentication data itself. A CF 310 can be assigned to the cut definition 308-2. As shown, by row 306-0 (the primary user/owner of the system) can have a relatively high CF of 0.8. Row 306-1 (not the primary user) can have a lower CF of 0.2.

Access granted 312 can show the type of access granted in response to the CF value. In the embodiment shown, the high CF (0.8) generated by the presence of Steve's phone can provide full access. In contrast, the lower CF (0.2) generated by the presence of Sara's smart watch can provide one or more lesser accesses (other access). Examples of other accesses can include entry access (e.g., doors can unlock) or access to features of the system (infotainment system, hotspot access etc.).

In this way, authentication information for different users, representing different levels of access for a system, can be stored for access by the system.

According to embodiments, increasing the number of authentication sources for a same user can alter the amount of access (e.g., levels of permission) for a system. FIGS. 4A and 4B show examples of such an arrangement.

FIGS. 4A and 4B show a system 414 that can include multiple input sub-systems, including a wireless system 416-0 and finger print system 416-1. A system 414 can have various permissions including full access 412-0 and a lower level access 412-1. Full access 412-0 can be assigned a certainty threshold value of 0.8, while the other access can be assigned a certainty threshold of 0.2.

FIG. 4A shows permissions of a system 414 in the presence of a first device 418-0. A first device 418-0 can be a smart watch that can be detected by wireless system 416-0. System 414 can have a CF value stored for the first device 418-0, which is 0.2. With only a first device 418-0, a certainty score can be 0.2. As shown, this is not sufficient for full access 412-0 (CS is not greater than or equal to 0.8), but is sufficient for the other access (CS is greater than or equal to 0.2).

FIG. 4B shows permissions of a system 414 in the presence of multiple devices/data. In the example shown, as more devices are added, an overall CS can increase. FIG. 4B shows a second device (head phones) with a CF of 0.3 and third data (a matching fingerprint) 418-2 with a CF of 0.4. A fingerprint match can be generated with a fingerprint system 416-1 by comparing a finger print detected by a sensor to a fingerprint data file stored (or securely accessed) by the system 414. In the embodiment shown, CF devices can be added to generate a CS. Thus, with the addition of second device 418-1 and data 418-2, a certainty score can be 0.9, which is sufficient for full access 412-0, as well as other access 412-1.

While FIG. 4B shows a system that sums CFs to generate a CS, embodiments can use any other suitable function. Further, while FIG. 4B shows CFs that are positive, other embodiments can include CFs that are negative.

In this way, multiple authentication sources can be used to enable any number of access types (e.g., permissions) of a system.

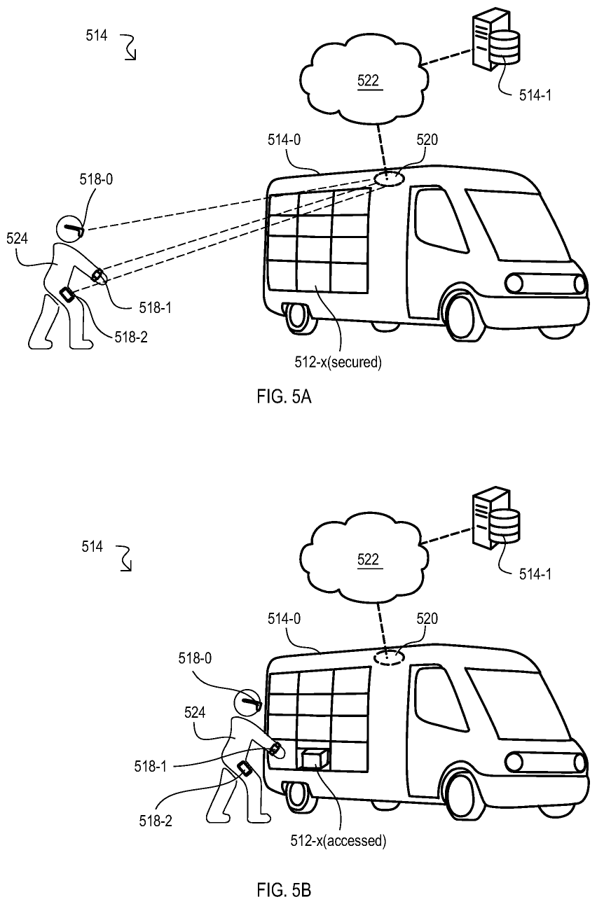

FIGS. 5A and 5B show a delivery system 514 according to an embodiment. A System 514 can include a delivery vehicle 514-0 and server system 514-1. A server system 514-1 can be in communication with a delivery vehicle 514-0 through a network 522, which can include the internet. A delivery vehicle 514-0 can include storage compartments (one shown as 512-x) and a central permission decision system 520. Storage compartments 512-x can each have an assigned permission level (e.g., certainty threshold). A compartment 512-x can have an access level corresponding to authentication data/devices (e.g., passport) for a user 524 (e.g., subject of a delivery).

A central permission decision system 520 can control permissions for the various compartments 512-x based on data stored locally or received from server system 514-1. A system 514 can store passports for multiple people (e.g., delivery recipients) and have assigned threshold values to the corresponding compartments. Referring to FIG. 5A, when a user 524 comes within a predetermined range, a central permission system 520 can detect one or more devices 518-0 to 518-2 of the user 524. Any or all of the devices 518-0 to -2 can be included in a passport for the user 524, and thus can include a CF. A central permission system 520 can generate a CS value from all detected CFs and compare it to a threshold assigned to the compartment 512-x. It is understood that a system 514 can include any other authentication data inputs as described herein or equivalents (e.g., thumbprint).

As shown in FIG. 5B, if the CS meets the threshold, the compartment 512-x can be opened or unlocked, allowing a user 524 to access delivery items.

In this way, a delivery system can store sets of user authentication data with CF values. Access to different compartments of the system can be assigned to a user and assigned a certainty threshold. When a user's detected CFs result in exceeding the certainty threshold of their assigned compartment, the compartment can be made available.

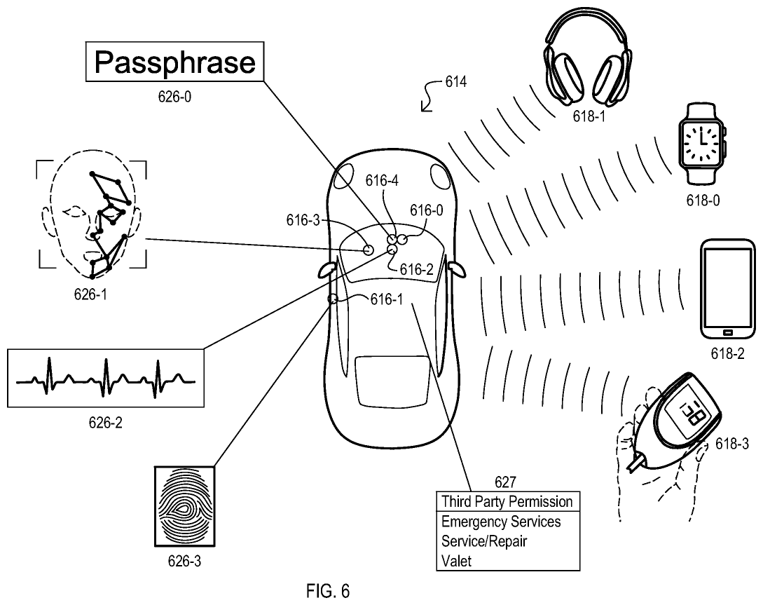

FIG. 6 is a diagram of a motor vehicle system 614 and operations according to an embodiment. System 614 can include various input sub-systems for receiving or detecting user authentication data from multiple sources. In the embodiment shown, system 614 can include a wireless communication system 616-0, a fingerprint reading system 616-1, a microphone system 616-2 (e.g., audio system), a camera system 616-3, and a user interface 616-4. A wireless communication system 616-0 can receive wireless transmissions from various devices associated with users. While any suitable device can be included, FIG. 6 shows four specific, but non-limiting examples, including a smart watch 618-0, head phones 618-1, a smart phone 618-2 and medical equipment 618-3 (e.g., glucose meter). The various devices (618-0 to 618-3) can have CF values which can be assigned automatically or assigned by a user. Some devices can have a higher CF based on the type of device.

In some embodiments, a system 614 can be responsive to devices/data of third parties 627. Such device or data can be from authenticated or otherwise certified persons or services to enable such third parties appropriate permission for their function. While third party permission 627 can take any suitable form, the embodiment of FIG. 6 shows emergency services, service or repair (which can result in range/geographic limitations) and valet (which can result in speed/range/geographic limitations). Such third party limitations can be enabled by a user setting a feature of a system, or by the third party having the appropriate authorized device(s)/data that results in the suitable CS value.

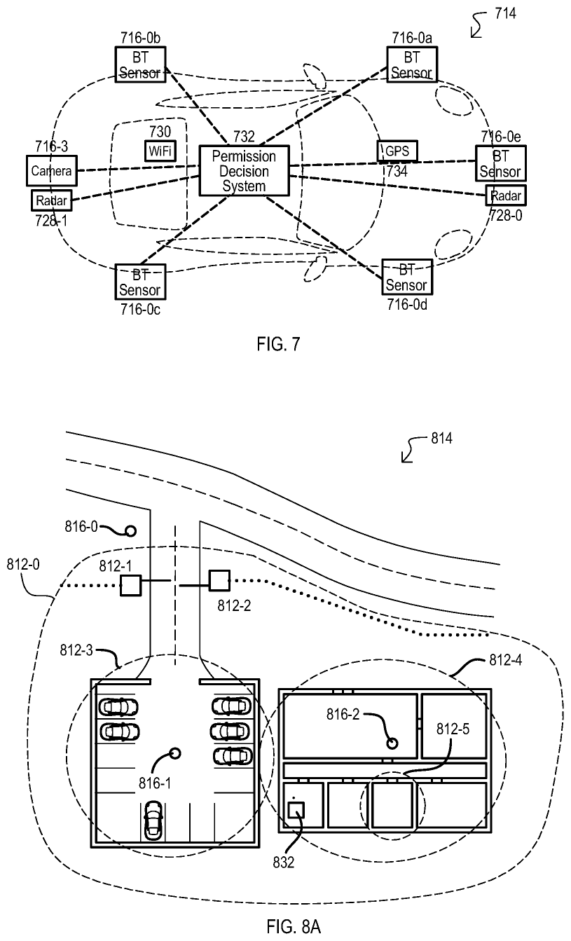

FIG. 7 is a diagram of a motor vehicle system 714 according to another embodiment. System 714 can use various sensors for acquiring authentication data from users and/or user devices. A system 714 can include a permission decision system 732 in communication with BT sensors 716-0a to 716-0e, radar sensors 728-0/1, a camera 716-3, and a WiFi system 730. Any or all BT sensors (716-0a to -0e) can detect packets transmitted from user BT devices, which can be used to identify user devices that serve as authentication data sources, as described herein and equivalents. A WiFi system 730 can be used to receive authentication data from WiFi compatible devices. In some embodiments this can include a WiFi system determining positioning/proximity from a GPS 734 or other positioning system. In other embodiments, WiFi peer-to-peer communications can be used to directly receive user device data. Optionally, other sensors, such as cameras 716-3 or radar sensors 728-0/1 can be used to generate or acquire user authentication data for making a multi-layered determination for access permissions.

In this way, a system can use existing sub-systems and sensors to detect or receive authentication data from different sources, where combinations of access data can enable various levels of access to the system.

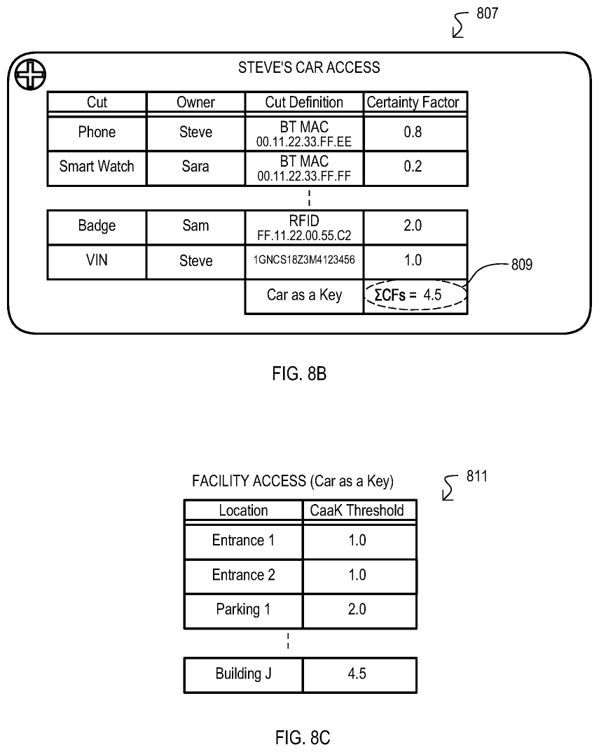

Embodiments can include any suitable system having different access types. While embodiments disclosed herein have shown motor vehicle systems, this should not be construed as limiting. FIG. 8A shows a campus system 814 according to an embodiment. A system 814 can include a number or sensor systems (three shown as 816-0 to 816-2) in communication with a permission decision system 832. Sensor systems (816-0 to 816-2) can take the form of any of those shown herein, as well as any other suitable system that can acquire authentication data from a user. Authentication data from multiple sources for a same user can be combined to arrive at a CS, which can enable different types of access to the system.

In the embodiment shown, types of accesses can include, but are not limited to, full access 812-0, entrance access 812-1, exit access 812-2, parking access 812-3, building access 812-4 and room access 812-5. It is understood that each such access 812-0 to -5 can be assigned a different certainty threshold as described herein.

In this way, embodiments can include systems other than motor vehicles.

According to some embodiments, authentication can have higher levels of hierarchy, with collective certainty factors representing a superset of authentication that can authenticate a larger group or larger device. Such a group/device can include any suitable device/vehicle, including but not limited to: automobiles, commercial equipment such as cranes, earthmovers, as well as lawn mowers or the like. Such vehicles can be driven by a person, can be autonomous or a combination thereof. Alternatively, a group of people traveling together (e.g., within a predetermined proximity to one another) can form a collective authentication value. If one of person in the group is not within proximity to the others, their authentication contribution (e.g., cut) is not included in a test against a certainty threshold. In some embodiments, autonomous vehicles can act as a representation of one or more persons (e.g., act as an avatar), enabling the vehicle carry the CF(s) of the owner(s) as it executes various tasks for the owner(s) (e.g., pick up food, dry cleaning).

FIG. 8B is a diagram showing how different authentication sources can be grouped to arrive at a collective authentication value, which can authenticate a device/group. FIG. 8B shows values for a motor vehicle (Steve's Car), like that shown in FIG. 3. The various authentication sources can have a CF, with all CFs being summed to arrive at a higher level authentication value 809 for the vehicle (e.g., “Car as a Key”). It is understood any suitable method can be used to arrive at a higher level authentication value, including but not limited to: filtering out some kinds of authentication sources or weighing some authentication sources to a greater or lesser amount than others.

FIG. 8C is a diagram showing threshold values 811 assigned to locations of a facility that can enable or disable access based on a higher level authentication value (e.g., “Car as a Key”).

In this way, a vehicle and/or group of people can have a superset of authentication to enable access to systems, locations or data according to a certainty threshold that is compared to the superset of authentication.

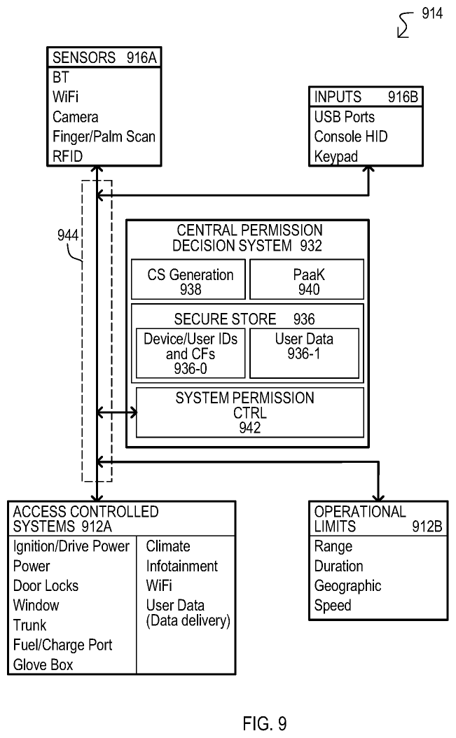

FIG. 9 is a block diagram of an automotive control system 914 according to an embodiment. A system 914 can include a central permission decision system 932, sensors 916A, inputs 916B, access controlled systems 912A and operational limits 912B. A bus/communication system 944 can enable communication between the various portions of the system 914. A central permission decision system 932 can include a secure store 936, a CS generation function 938, system permission control function 942 and a phone as a key (Paak) function 942. A secure store 936 can include memory circuits that can only be accessed by predetermined operations and/or is protected by encryption. A secure store 936 can store user and device identification values with their corresponding CFs 936-0. Such data can take the form of “passports” as described herein, with authenticating devices/data each having a corresponding CF. In some embodiments, a secure store 936 can store other user data 936-1 which can be accessed with a sufficiently high CS.

A CS generation function 938 can generate a CS value from detected CFs as described herein and equivalents. Paak 940 can provide a conventional phone-as-a-key function. A system permission control function 942 can enable or disable various systems 912A and/or operational limitations 912B in response to a generated CS. Functions 940, 938, 942 can be executed by any suitable circuits, including but not limited to, processors executing instructions, custom logic, programmable logic, or combinations thereof.

Systems 912A that can be controlled in response to a CS value can include, but are not limited to: ignition/drive power, electrical power, door locks, window control, trunk, fuel/charge port, glove box, climate control, infotainment system, a WiFi system and user data 936-1. According to embodiments, each of these systems or data can be assigned a certainty threshold to which a CS can be compared to decide whether to enable or disable access to the system/data. User data 936-1 can be a repository of data that a user may wish to access, or enable others to access. In some embodiments, such access can include data delivery of digital assets. Operational limits 912B that can be set or enabled in response to a CS value and can include, but are not limited to: range, duration of operation, geographic area of operation and speed. Such limits can be set by user, and can each have an assigned certainty threshold.

In this way, a centralized permission decision system can receive authentication data from multiple different sources, can weigh such multiple authentication data to enable any of numerous permissions, each of which can have its own permission level.

While embodiments can include systems with various interconnected components, embodiments can also include a unitary controller device for a system, such as a motor vehicle, that can receive different types of authentication information, and provide varying levels of access based on different types of authentication for a same user. Such a system and be included in a single integrated circuit package, including a device formed with a single integrated circuit substrate.

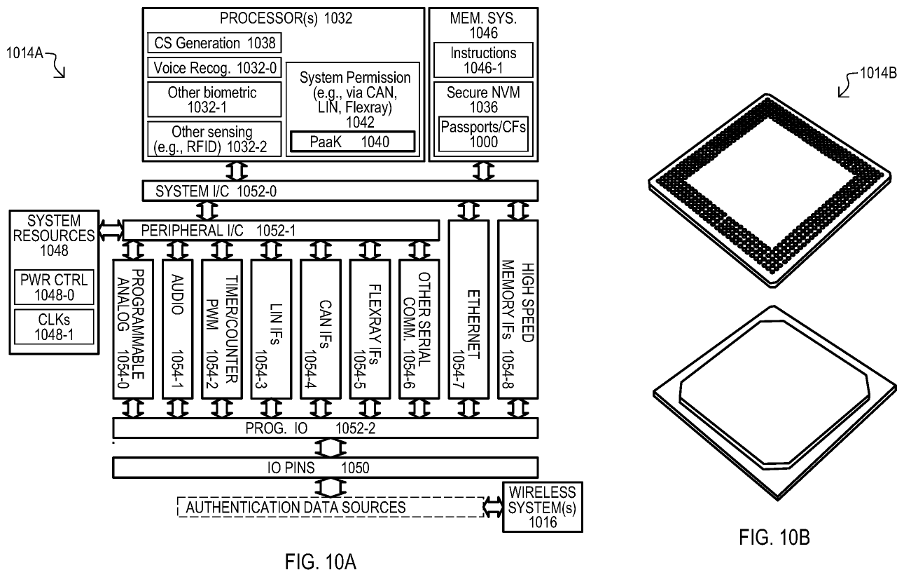

FIG. 10A shows a single integrated circuit device according to an embodiment. A system 1014A can be a system-on-chip (SoC) type device, and can include a processor system 1032, a memory system 1046, system resources 1048, input/output (IO) pins 1050, system interconnect (I/C) 1052-0, peripheral I/C 1052-1, programmable IO 1052-2, and various circuit sections 1054-0 to 1054-8. Processor system 1032 and memory system 1046 can be in communication with one another by system interconnect 1052-0.

Processor system 1032 can include one or more processor circuits and can provide functions by executing instructions 1046-1 stored in a memory system 1046. Such functions can include CS generation 1038 as described herein, as well as system permission control 1042, which can control access to various systems via interfaces as described herein. In the embodiment shown, such permissions can also include PaaK permissions 1040. Functions can further include voice recognition 1032-0, which can compare a received voice data file to any stored in passports/CFs of memory system 1046. In some embodiments, processor system 1032 can execute other biometric functions (e.g., face recognition) and provide other processing to authenticate input data received from various other sources.

Memory system 1046 can include secure nonvolatile memory (NVM) 1036 that can store passport data with corresponding passports and/or CFs 1000 as described herein, or equivalents.

System resources 1048 can provide or control various system resources of the SoC 1014A, and can include power control 1048-0 and timing clocks 1048-1. Power control 1048-0 can control power to the system 1014A, including placing sensors and/or inputs into a sleep mode between data acquisition operations (e.g., operations that can acquire authentication data).

Circuit sections 1054-0 to 1054-6 can be connected between peripheral I/C 1052-1 and programmable IO 1052-2. Programmable analog circuit section 1054-0 can include analog circuit elements that can be configured with configuration data. Audio circuit section 1054-1 can include circuits for processing audio data, including receiving audio data from a microphone, or the like. Timer/counter PWM 1054-2 can control pulse width modulation operations for the system 1014A.

Local interconnect network (LIN) interface section 1054-3, controller area network (CAN) section 1054-4 and Flexray section 1054-5 can provide one or more interface circuits compatible with CAN, LIN and Flexray standards. LIN/CAN/Flexray sections 1054-3 to -5 can be used to control access to various external systems according to a CS value generated by processor system 1032. In some embodiments, LIN/CAN/Flexray sections 1054-3 to -5 can also provide data for authentication from sensors (e.g., other devices on a LIN/CAN/Flexray bus) for use by processor system 1032.

Other serial communication section 1054-5 can provide an interface compatible with one or more other serial communication standards, and can also serve as a source of data for authentication (from an external sensor/input) and/or be used to control access to other external systems in response to a CS value.

The embodiment of FIG. 10A also includes Ethernet section 1054-7 and high speed memory interface 1054-8 connected between systems I/C 1052-0 and programmable IO 1052-2. Ethernet section 1054-7 can provide an interface compatible with one or more Ethernet standards, including various IEEE 802.1 standards. In some embodiments, communications via Ethernet section 1054-7 can serve as a source of data for authentication and/or be used to control access to other external systems in response to a CS value. High speed memory IFs 1054-8 can enable communications according to one or more high speed memory standards (e.g., SMIF, SDHC).

Programmable IO 1052-2 can be configured according to configuration data to provide various connections between IO pins 1050 and circuit sections 1054-0 to 1054-8. IO pins 1050 can be connected to various other external systems, including those that provide authentication data, which can include other wireless systems 1016 or modules.

FIG. 10B shows a packaged single chip controller system 1014B. System 1014B can include circuits like those shown in FIG. 10A and/or serve as part or all of an access permission system as described herein and equivalents. Thus, a system can be formed in a single integrated circuit package, including in a same integrated circuit substrate.

In this way, a system can include a single integrated circuit device configured to receive data for authentication, generate an authentication score (e.g., CS) that can be used to enable various levels of access for device controlled by the system. However, it is understood that a device according to embodiments can include any other suitable integrated circuit packaging type, as well as direct bonding of a device chip onto a circuit board or substrate.

While the devices and systems described herein have disclosed various methods according to embodiments, additional methods will now be described with reference to flow diagrams.

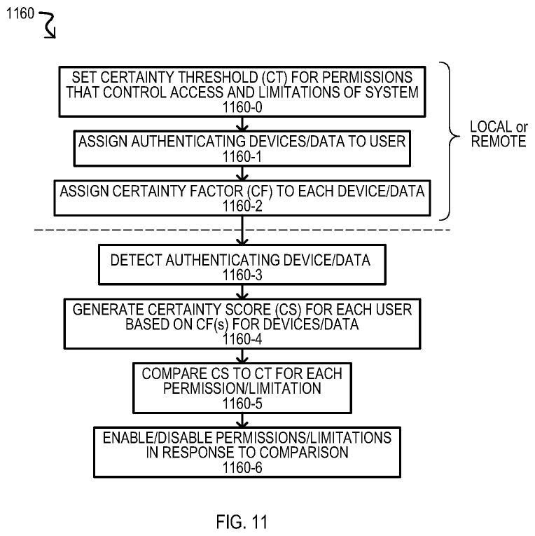

FIG. 11 is a flow diagram of a method 1160 according to an embodiment. A method 1160 can include setting a certainty threshold (CT) for each permission that control access to a system or that imposes limitations to the system 1160-0. Authenticating devices and/or data can be assigned to a user 1160-1. Such an action can include any of those disclosed herein or equivalents, including creating a “passport” for a user. A CF can be assigned to each device/data 1160-2. In some embodiments, actions 1160-0 to -2 can include a user accessing an interface an entering the various values. As shown in FIG. 11, actions (1160-0 to -2) can be performed remotely from a system, or locally at a system. Remote actions can include a user accessing an application or the like, which can enable the various values to be transferred to a system. Local actions can include a user entering the various values by way of one or more user interfaces of the system.

A method 1160 can further include detecting authenticating devices and/or data 1160-3. Such an action can include determining if data received from a device or input to a system can be considered to sufficiently match authentication data previously entered (e.g., already in a passport). A CS can be generated for each user based on CFs for the devices/data of that user 1160-4. As noted herein, generation of a CS can take any suitable form, including adding CFs. A generated CS can be compared to the CT for each permission or limitation 1160-5. The permissions/limitations of the system can then be enabled or disabled in response to each comparison 1160-6.

In this way, a method can assign CTs for various accesses of a system, assign CFs for various types of communication, generate a CS from the CFs, and enable or disable in response to a comparison between the CS and corresponding CTs.

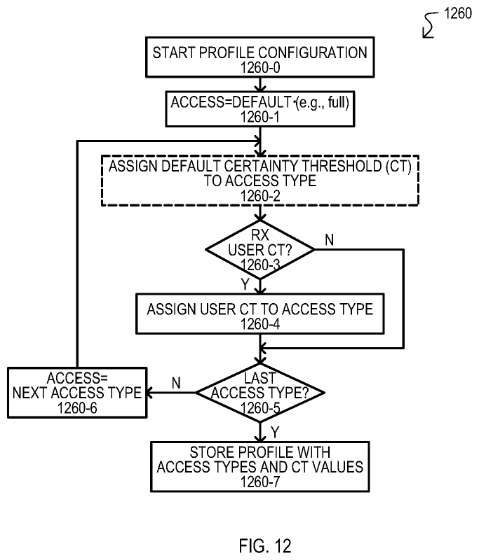

FIG. 12 is a flow diagram of a method 1260 for configuring an access (e.g., permissions) profile according to an embodiment. A method 1260 can include starting a profile configuration 1260-0. Such an action can include a user starting a configuration application or the like. Such an application can be remote (e.g., via communication with a server) or local (e.g., via an interface of the system). A method 1260 can start with one of multiple accesses types (e.g., permissions) 1260-1, which in the embodiment shown can be a default access type (e.g., full access to all permissions).

In some embodiments, a method 1260 can assign a default CT to a current access 1260-2. Such an action can include assigning a highest CT by default. But alternate embodiments can have different default CTs for different access types.

A method 1260 can determine if a user CT value is received 1260-3. Such an action can include receiving a user CT value from an interface or application. If a user CT is received (Y from 1260-3), the received CT can be assigned to the particular access 1260-4. If a user CT is not received (N from 1260-3) a default state of the assignment can be applied (e.g., no access or highest CT).

While a last access type has not been reached (N from 1260-5), a method 1260 can proceed to a next access type 1260-6. Such an action can include a user selecting a next access type according to an application, or an application presenting a next access type for user. A CT can then be assigned to such an access. Once a last access type is reached (Y from 1260-5), a method 1260 can store a profile with access types and assigned CT values. In some embodiments, this can include storing such data in a secure memory.

In this way, CT values can be assigned to various accesses of a system.

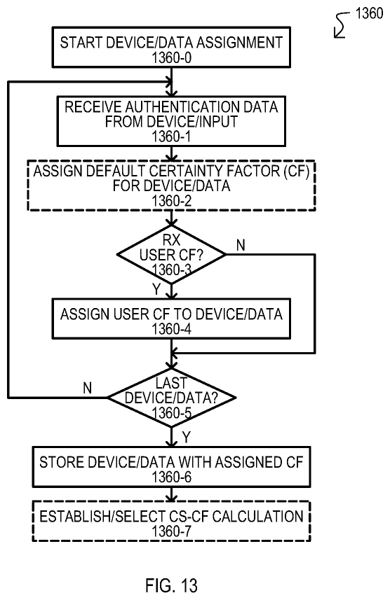

FIG. 13 is a flow diagram of a method 1360 for assigning CF values to various authentication sources according to an embodiment. A method 1360 can start 1360-0, which can occur in the same manner as that of FIG. 12. A method 1360 can receive authentication data from a device or input 1360-1. Such an action can include a user entering the information through an interface, a system detecting the information through sensors, a system receiving the information from an application running on another device, or a system accessing a secure system to download the information. Authentication data can take the form of any of those described herein, or equivalents, including but not limited to: device ID values (e.g., MAC addresses) sensed in a wireless fashion, or sensed by being connected to a port; biometric data files acquired by the system (e.g., a fingerprint reader) or provided by a user in a predetermined data format; and values (e.g., passwords, PINs) entered via an interface (remotely or via a system interface).

In some embodiments, a method 1360 can assign a default CF for the device (e.g., device ID) or data that will be used for authentication. Such an action can include assigning a lowest CF (e.g., zero, or otherwise not contributing to authentication). But alternate embodiments can have different default CFs for different devices/data.

A method 1360 can determine if a user CF value is received 1360-3 for the device/data. Such an action can include receiving a user CF value from an interface or application. If a user CF is received (Y from 1360-3), the received CF can be assigned to the particular device/data 1360-4. If a user CF is not received (N from 1360-3) a default state of the assignment can be applied (e.g., lowest or no CF).

While authentication data for a last device/data has not been reached (N from 1360-5), a method 1360 can return to 1360-1 (receive authentication data for a next device/input). Once a last device/data has been reached (Y from 1360-5), a method 1360 can store the device/data authentication data with the assigned CF 1360-6. In some embodiments, this can include storing such data in a secure memory.

Optionally, a method 1360 can include selecting a type of calculation used to generate a CS from the assigned CFs 1360-7. However, alternate embodiments will have one CS calculation (e.g., CS is a summation of all CFs).

In this way, CF values can be assigned to various authentication sources of data, enabling access to be established based on multiple authentication sources.

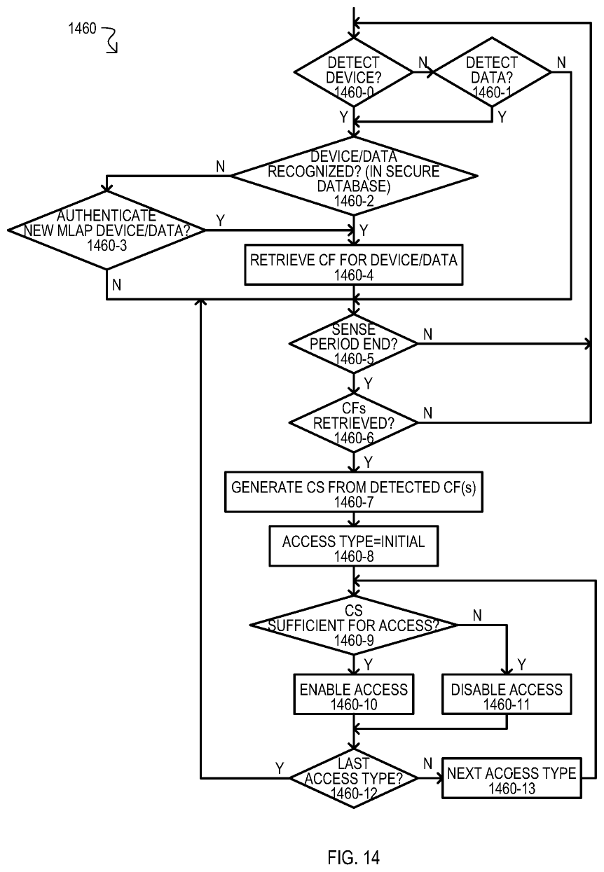

FIG. 14 is a flow diagram of a method 1460 for granting various levels of access/permissions to a system based on multiple authentication sources. A method 1460 can include determining if an authenticating device has been detected 1460-0. Such an action can include sensing wireless packets transmitted by a device that include identifying information or detecting the connection of a device to a physical port, and following a protocol to identify the device. A method 1460 can also include determining if authenticating data has been received 1460-1. Such an action can include generating data from sensors (e.g., biometric sensors), receiving data at a physical port, or receiving data via an interface.

If an authenticating device is detected or data received (Y from 1460-0/1), a method 1460, can determine if the device/data are recognized (e.g., included in a user passport). Such an action can include determining if a device ID or other data matches that stored in a secure database. A “match” can be an exact match, or match of sufficient degree (e.g., biometric match). If a device/data are recognized (Y from 1460-2), a CF for the device/data can be retrieved 1460-2.

In some embodiments, if a device/data does not match a current database, it can be ignored. However, in the embodiment shown, if a device/data does not match a current database (N from 1460-2), a method 1460 can attempt to authenticate the device/data using a remote server through an authentication process (e.g., one that uses PKI infrastructure). If a new device/data can be authenticated, it can have a CF which can be retrieved 1460-4.

Device and data detection can continue over a predetermined sense period (N from 1460-5). When a sense period ends (Y from 1460-5), a method 1460 can determine if CFs have been retrieved 1460-6. If CFs have not been retrieved (N from 1460-6), a method 1460 can return to attempting to detect authenticating devices/data.

If CFs have been retrieved (Y from 1460-6), a method 1460 can generate a CS from retrieved CFs for each given user 1460-7. Such an action can include any of those described herein, or equivalents.

Once a CS has been generated, a method 1460 can compare the CS to the various access types of a system, and grant or deny access based on the CS value. In the embodiment shown, a method 1460 can start with an initial access type 1460-8, which can be a primary access (e.g., full access). A determination can be made as to whether the CS is sufficient for the access type 1460-9. Such an action can include comparing a CS value to a CT assigned to the access. If a CS value is sufficient for the access (Y from 1460-9), access can be enabled 1460-10. If a CS value is not sufficient for the access (N from 1460-9), access can be disabled 1460-11. Such an evaluation can occur for each access type (N from 1460-12, 1460-13), until a last access type has been evaluated (Y from 1460-12). The monitoring process can then repeat for another sense period.

While embodiments can include previously stored authenticated devices/data (e.g., passports), alternate embodiments can dynamically add devices that can be identified and authenticated through an existing authentication system, such as one utilizing a public key infrastructure (PKI).

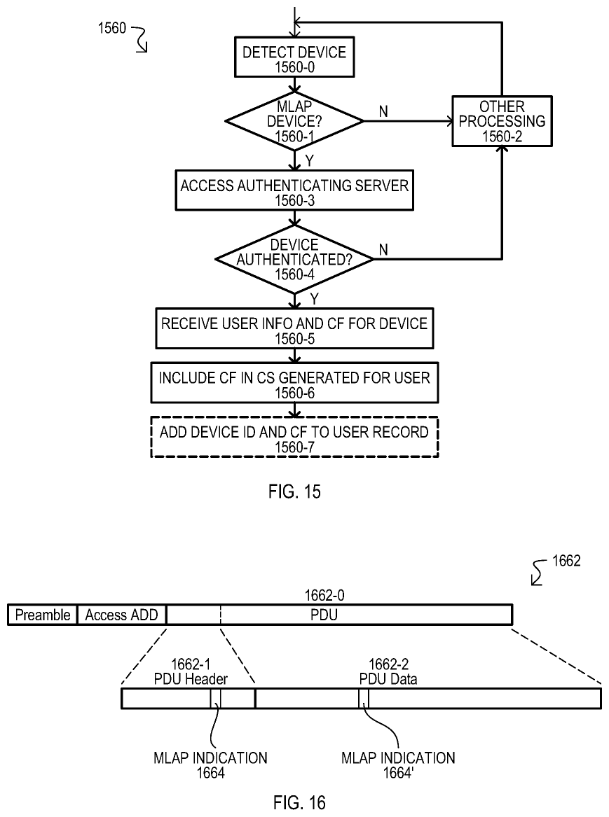

FIG. 15 is a flow diagram of a method 1560 for adding a device to a multi-layered authentication and permissions (MLAP) system according to an embodiment. A method 1560 can include detecting a new device 1560-0. Such an action can include detecting such a device via a wireless communication (receive a packet) or detect a device connected to a physical port. Once a device is detected, a method can determine if the device is compatible with an MLAP system 1560-1. Such an action can include determining MLAP identifying values from a communication received from the device. In some embodiments this can include examining one or more predetermined fields of a packet. If a device is not MLAP compatible (N from 1560-1), other processing can take place 1560-2 (i.e., processing unrelated to an MLAP system), including ignoring the device.

If a device is MLAP compatible (Y from 1560-1), a method 1560 can access authenticating server 1560-3. Such an action can include contacting a server according to a predetermined protocol (e.g., https, tlds). Such a server is understood to store devices previously determined to be compatible with a MLAP system. Such determination can include the use of security certificates or the like. If the newly detected device cannot be authenticated (N from 1560-4), a method 1560 can proceed to other processing 1560-2.

If the newly detected device can be authenticated (Y from 1560-4), a method 1560 can receive user information and a CF for the device 1560-5. Such an action can include receiving such data over a secure connection to the authenticating server, for example. Such user and CF data can then be included in generating a CS for the user 1560-2. Such an action can include generating a CS according to any of the embodiments described herein, or equivalents. Optionally, the new data for the device can be added to a user record 1560-7. Such an action can include adding the new device data to a user record (e.g., passport) with the corresponding CF. Such a record can be stored local and/or remotely, as described herein.

FIG. 16 is a diagram of packet structures 1662 for identifying MLAP devices according to embodiments. A packet 1662 can be transmitted from a user device, and can include a header portion 1662-1 and a payload portion 1662-2. A value indicating MLAP compatibility can be data 1664 (labeled as MLAP INDICATION) included in a header portion, or alternatively, data 1664′ (also labeled as MLAP INDICATION) included in a payload portion. Such a value can be detected by a system to confirm the device, if authenticated, can be used in calculating various levels of permissions in the system. In a particular embodiment, a packet 1662 can be compatible with one or more BT standards, having a protocol data unit (PDU) 1662-0, with the MLAP indication being included in the PDU header or PDU payload data.

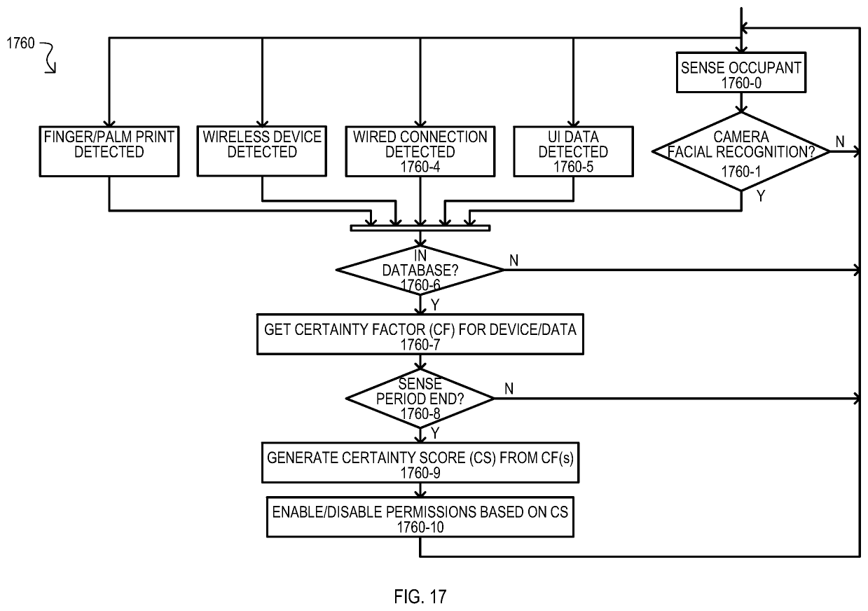

FIG. 17 is a flow diagram of a motor vehicle permission control method 1760 according to an embodiment. A method 1760 can include sensing an occupant of the vehicle 1760-0. Such an action can include detecting an occupant with any suitable sensor systems of vehicle. Once an occupant is sensed, a method 1760 can attempt to perform a face recognition on the occupant 1760-1. Such an action can include utilizing cameras on the vehicle to sense facial features of an occupant. In some embodiments, such an action can generate a biometric data file. If facial recognition is not possible, or there is no match (N from 1760-1), a method 1760 can return to monitoring sensors/inputs.

Other sensors of the system can execute similar operations. A finger or palm print sensor can detect a finger of palm print 1760-2 and generate a biometric data file therefrom. Wireless systems can detect a wireless device 1760-3. Such actions can include, but are not limited to, receiving data packets from a wireless device that can include identifying information (e.g., MAC address) for the device. One or more ports on the vehicle can detect when a device is physically connected to the vehicle 1760-4. A vehicle can detect when a user enters data via one or more user interfaces 1760-5.

In response to detected inputs, including successful facial recognition (Y from 1760-1), a method can determine if data from the event is stored in a database 1760-6. Such an action can include, but is not limited to: determining if a biometric file (e.g., finger/palm print, facial recognition result) sufficiently matches a corresponding authenticated biometric data file; determining if a device ID matches corresponding data in the database; and determining if user entered data matches data stored in the database. If no database matches occur (N from 1760-6), a method can return to monitoring sensors/inputs. A database can be a secure data base that stores user records/passports and CF data as described herein or an equivalents. A database can be remote, local or a combination thereof.

For each device/data that matches a value in the database, a CF factor can be determined 1760-7. In some embodiments, this can include accessing a CF value associated with the corresponding value of the database. While a sense period continues (N from 1760-8), sensors/inputs can continue to be monitored, and CFs generated for any further matching devices/data.

When a sense period has ended (Y from 1760-8), a method 1760 can generate a CS from all CFs retrieved 1760-9. Various permissions for the vehicle, which may each have different CTs, can be enabled or disabled according to the CS 1760-10. Actions 1760-9 and 1760-10 can take the form of any of those described herein or equivalents.

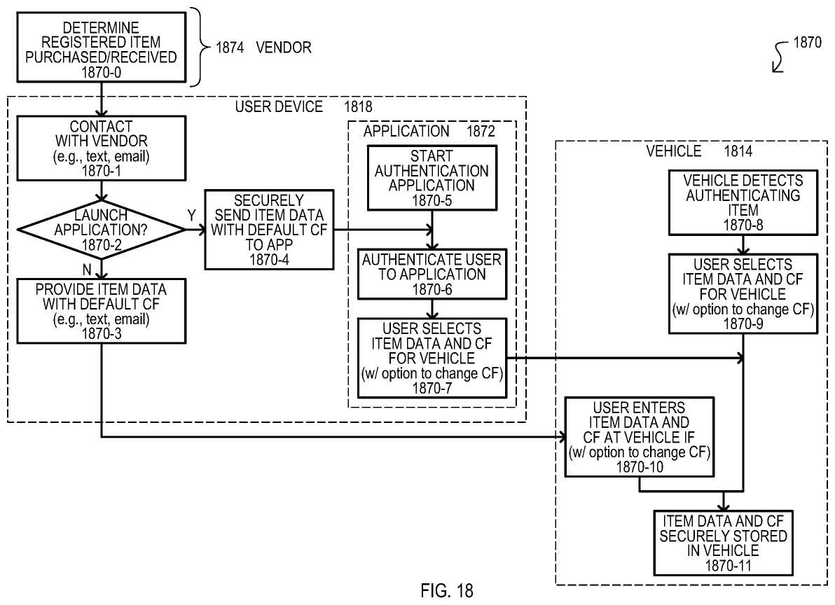

FIG. 18 is a diagram of a method 1870 for receiving authenticating device data according to an embodiment. A method 1870 can include operations by a vendor 1874, a user device 1818 and a vehicle 1814. A vendor 1874 can determine when a registered item is purchased or otherwise received by a user 1870-0. A registered item can be an item that is manufactured to be compatible with an authentication system as described herein, or equivalents. In some embodiments, a manufacturer can assign a CF to a registered item, which may or may not be adjusted by a user. In some embodiments, a registered item can communicate with a vehicle to identify itself as an MLAP device. In some embodiments, a user can provide a vendor 1874 with contact information (e.g., phone number, email address, social media identification).

A user device 1818 can be any suitable device configured to execute an authentication application 1872, including but not limited to a smart phone, tablet computing device, laptop computer or desk top computer. In some embodiments, a user device 1818 can be in communication with one or more server devices, such as a server run by a vendor. Once a user has purchased/received a registered item, a user can be contacted via a user device 1870-1 (or the user can contact the vendor). Such an action can include notifying a user that the registered item can serve as an authenticating device. Such contact can take any suitable form including but not limited to a text message, email message or social media message. It is noted that in some embodiments there may be no contact with a vendor, and the registered device can identify itself as an authenticating device.

In the embodiment shown, in response to communications with a vendor, a user can be given the option to launch an authentication application 1870-2 (which can be resident on the user device 1818). If an application is not launched (N from 1870-2), item data and a default CF can be provided to the user 1870-3. A user may subsequently enter such data at an interface for the vehicle (1870-10). Such an option can include the ability of a user to change the CF assigned by the vendor. If an application is launched (Y from 1870-2), item data and a default CF can be securely transferred to the application 1870-4.

If a user starts an authentication application 1870-5, or such an application has been automatically launched (1870-4), the user can be authenticated to the application 1870-6. Such an action can take any suitable form, including built-in biometrics and/or two-part authentication, as but two of many possible examples. Once a user is authenticated, a user can select the item data and CF for a vehicle 1870-7. Such an action can include selecting a newly entered registered item and/or any other possible authentication sources detected by, or previously entered into, the application 1872. Such an action can include the ability of a user to change the default (or otherwise existing) CF of the item. In other embodiments, such actions can be indirect, with an application 1872 communicating with a server (not shown), and the server communicating with the vehicle 1814.

An application 1872 can then communicate with a vehicle 1814 and the item data and CF can be securely stored in the vehicle 1870-11. Such an action can take the form of any of those described herein, or equivalents.

Referring still to FIG. 18, a vehicle 1814 can detect authenticating items 1870-8. Such an action can take the form of any of those described herein and equivalents. As described herein, for items detected by a user, the item data and CF can be selected by a user (with the option to adjust a CF) 1870-9. The item data and CF can be securely stored in the vehicle 1870-11.

In this way, vendors and provide items compatible with a multi-layered authentication and permission system that have a initial CF value which may, or may not be adjusted by a user.

While embodiments can include various devices, systems and methods, embodiments can also include authentication applications executable on user devices to assign authentication values (e.g., CFs) for a vehicle system that establishes authentication/permissions using multiple sources.

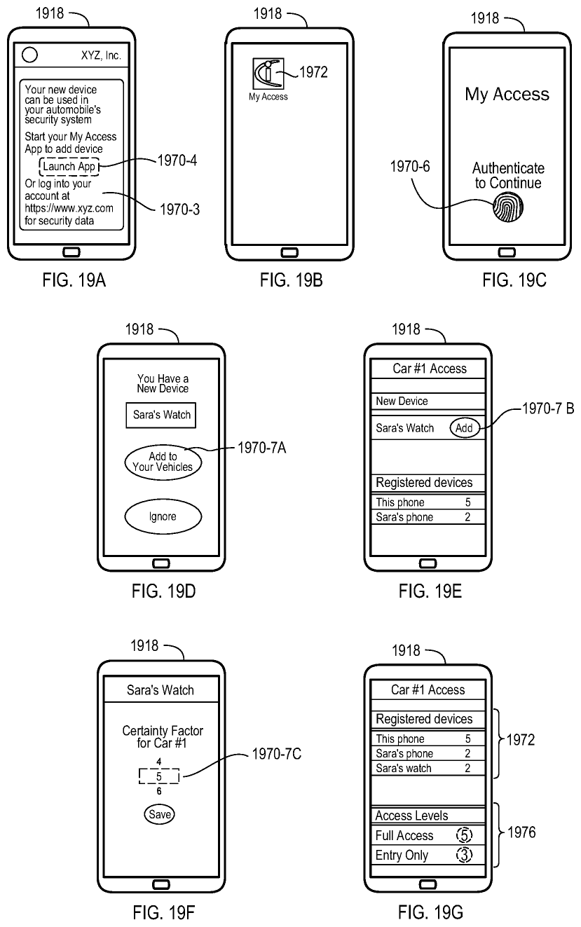

FIGS. 19A to 19G are a series of diagrams showing a user device 1918, application 1972 and related operations according to an embodiment. In some embodiments, application 1972 can correspond to that shown as 1872 in FIG. 18. However, FIGS. 19A to 19G show but one implementation of an application and should not be construed as limiting.

FIG. 19A shows communications that can be received from a vendor for a registered device. Such communications can give the option of a user to start an authentication application 1970-4 or access security data (e.g., registered device and CF value) from another source 1970-3.

FIG. 19B shows an application 1972 resident on a user device 1918 that may be launched by a user, or launched automatically from a vendor message (e.g., 1970-4). FIG. 19C shows how an application 1972 can include an authentication step 1970-6. Once a user has been authenticated, as shown by FIG. 19D, an application can identify any new authenticating devices and give a user the option to include such devices in a multi-layered authentication and permission system 1970-7A.

FIG. 19E shows how a user can also be given the option to add a device to a particular vehicle 1970-7B. A device can have an initial CF score (e.g., default value, or value assigned by a vendor). FIG. 19F shows how a user can have the option to change the CF for a newly added device 1970-7C.

FIG. 19G shows how an application can show CF values for various devices 1972 assigned to a vehicle as well as threshold levels for various accesses of the vehicle 1976.

In this way, an application can enable a user to add authenticating items to a multi-layered authentication and permission system of a vehicle.

Embodiments can include methods, devices and systems that receive user input values via a plurality of inputs of a motor vehicle; determine if each received user input value corresponds to an authenticated user value in a secure memory of the motor vehicle. For each received user input value corresponding to an authenticated user value, a certainty factor corresponding to the authenticated user value can be accessed from storage in the secure memory. A certainty score can be generated from all accessed certainty factors. Each of a plurality of permissions for operating or accessing the motor vehicle can be enabled in response to a comparison between the certainty score and a certainty threshold assigned to each permission.

Embodiments can also include methods, devices and systems having a plurality of input systems configured to provide input user values; a secure memory configured to store authenticated user values, each with a corresponding certainty factor; and a control unit in communication with the input systems. The control unit can be configured to determine if each received user input value corresponds to one of the authenticated user values in the secure memory, and for each received user input data value corresponding to an authenticated user value, access the certainty factor corresponding to the authenticated user value. The control unit can also generate a certainty score from all accessed certainty factors, and enable each of a plurality of permission for the motor vehicle in response to a comparison between the certainty score and a certainty threshold assigned to each permission.

Embodiments can further include methods, devices and systems with a motor vehicle having a control unit configured to determine if received user input value correspond to any authenticated user value stored in a secure memory, for each received user input data value corresponding to an authenticated user value, access a certainty factor corresponding to the authenticated user value stored in the secure memory; generate a certainty score from all accessed certainty factors, and enable each of a plurality of permission for the motor vehicle in response to a comparison between the certainty score and a certainty threshold assigned to each permission. At least one interface can be configured to receive authenticated user values from users, enable users to establish the certainty factors for each authenticated user value, and enable users to establish the certainty threshold for each permission of the motor vehicle.

Methods, devices and systems according to embodiments can further include at least one wireless communication system configured to detect wireless devices; and receiving the user input values includes receiving a packet from a wireless device having a device identification value therein. At least one wireless communication system can include a Bluetooth compatible system, the device identification value can comprise a MAC address value for the wireless device.

Methods, devices and systems according to embodiments can further include at least one biometric related sensor. A user input value can include an input biometric data file. Determining if each received user input value corresponds to an authenticated user value can include determining if the input biometric data value sufficiently matches a stored biometric file in the secure memory. Biometric sensors systems can include any one of a fingerprint reader, camera with a facial recognition system, and a microphone with a voice recognition system.

Methods, devices and systems according to embodiments can further include generating the certainty score including the addition of a plurality of addends, where each addend corresponding to one certainty factor.

Methods, devices and systems according to embodiments can further include the enabling of permissions for access to motor vehicle functions. The permissions for the motor vehicle can include any one of full driver control, door access, trunk access, fuel/charging port access, window control and glove box access.

Methods, devices and systems according to embodiments can further include the enabling of limitations on operating the motor vehicle. The limitations for the motor vehicle can include any one of limits on operating range, limits on operating duration, limits on operating speed and limits on operating geographic location.

Methods, devices and systems according to embodiments can further include receiving user values; authenticating the user values; receiving a certainty factor for each user value from a user; and storing each user value as an authenticated user value with the corresponding certainty factor in the secure memory.

Methods, devices and systems according to embodiments can further include receiving permission thresholds from at least one user; and storing the permission thresholds in the secure memory.

Methods, devices and systems according to embodiments can further include an interface being part of the motor vehicle, or being separate from the motor vehicle.

Methods, devices and systems according to embodiments can further include a server system in communication with the interface and the motor vehicle. The server can be configured to provide authenticated user values with corresponding certainty factors to the motor vehicle, and provide certainty thresholds to the motor vehicle,

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
receiving user input values via a plurality of inputs of a motor vehicle;
determining if each received user input value corresponds to an authenticated user value in a secure memory of the motor vehicle;
for each received user input value corresponding to an authenticated user value, accessing a certainty factor corresponding to the authenticated user value stored in the secure memory;
generating a certainty score from all accessed certainty factors; and
enabling each of a plurality of permissions for operating or accessing the motor vehicle in response to a comparison between the certainty score and a certainty threshold assigned to each permission.

2. The method of claim 1, wherein:
the inputs of the motor vehicle include at least one wireless communication system configured to detect wireless devices; and
receiving the user input values includes receiving a packet from a wireless device having a device identification value therein.

3. The method of claim 2, wherein:
the at least one wireless communication system includes a Bluetooth compatible system; and
the device identification value comprises a media access control (MAC) address value for the wireless device.

4. The method of claim 1, wherein:
the inputs of the motor vehicle include at least one biometric related sensor;
the user input value includes an input biometric data file; and
determining if each received user input value corresponds to an authenticated user value includes determining if the input biometric data value sufficiently matches a stored biometric file in the secure memory.

5. The method of claim 1, wherein:
generating the certainty score includes adding a plurality of addends, each addend corresponding to one certainty factor.

6. The method of claim 1, wherein:
the enabling of permissions includes enabling access to motor vehicle functions.

7. The method of claim 1, wherein:
the enabling of permissions includes enabling limitations on operating the motor vehicle.

8. The method of claim 1, further including:
receiving user values;
authenticating the user values;
receiving a certainty factor for each user value from a user; and
storing each user value as an authenticated user value with the corresponding certainty factor in the secure memory.

9. The method of claim 1, further including:
receiving permission thresholds from at least one user; and
storing the permission thresholds in the secure memory.

10. A motor vehicle apparatus, comprising:
a plurality of input systems configured to provide input user values;
a secure memory configured to store authenticated user values, each with a corresponding certainty factor; and
a control unit in communication with the input systems and configured to
determine if each received user input value corresponds to one of the authenticated user values in the secure memory,
for each received user input data value corresponding to an authenticated user value, access the certainty factor corresponding to the authenticated user value;
generate a certainty score from all accessed certainty factors, and
enable each of a plurality of permissions for the motor vehicle in response to a comparison between the certainty score and a certainty threshold assigned to each permission.

11. The motor vehicle apparatus of claim 10, wherein:
the plurality of input systems includes a wireless communication system configured to receive packets from wireless devices; and
the authenticated user values includes a device identification values for at least one wireless device that is included in packets from the wireless device.

12. The motor vehicle apparatus of claim 10, wherein:
the plurality of input systems includes at least one biometric sensor system that generates a biometric data file for a user of the motor vehicle; and
the authenticated user values include at least one authenticated biometric data value for a user.

13. The motor vehicle apparatus of claim 12, wherein:
the biometric sensors systems are selected from the group of a fingerprint reader, camera with a facial recognition system, and a microphone with a voice recognition system.

14. The motor vehicle apparatus of claim 10, wherein:
the permissions for the motor vehicle are selected from the group of: full driver control, door access, trunk access, fuel/charging port access, window control and glove box access.

15. The motor vehicle apparatus of claim 10, wherein:
the permissions for the motor vehicle are selected from the group of: limits on operating range, limits on operating duration, limits on operating speed and limits on operating geographic location.

16. A system, comprising:
a motor vehicle having a control unit configured to
determine if received user input value correspond to any authenticated user values stored in a secure memory,
for each received user input value corresponding to an authenticated user value, access a certainty factor corresponding to the authenticated user value stored in the secure memory,
generate a certainty score from all accessed certainty factors, and
enable each of a plurality of permission for the motor vehicle in response to a comparison between the certainty score and a certainty threshold assigned to each permission; and
at least one interface configured to
receive authenticated user values from users,
enable users to establish the certainty factors for each authenticated user value, and
enable users to establish the certainty threshold for each permission of the motor vehicle.

17. The system of claim 16, wherein:
the at least one interface is part of the motor vehicle.

18. The system of claim 16, wherein:
the at least one interface is separate from the motor vehicle.

19. The system of claim 18, further including:
a server system in communication with the interface and the motor vehicle and configured to
provide authenticated user values with corresponding certainty factors to the motor vehicle, and
provide certainty thresholds to the motor vehicle,

20. The system of claim 16, wherein:
the control unit is configured to generate the certainty score by adding a plurality of addends, each addend corresponding to one certainty factor.
